(19) United States
(12) Patent Application Publication
(10) Pub. No.: US 2010/0252246 A1
(43) Pub. Date: Oct. 7, 2010

(54) HEAT EXCHANGER AND AIR CONDITIONER HAVING THE SAME AND MANUFACTURING PROCESS OF THE SAME

(76) Inventors: Ju Hyok Kim, Seoul (KR); Yong Cheol Sa, Seoul (KR); Han Choon Lee, Seoul (KR); Dong Hwi Kim, Seoul (KR); Hong Seong Kim, Seoul (KR); Sang Yeul Lee, Seoul (KR)

Correspondence Address: KED & ASSOCIATES, LLP, P.O. Box 221200, Chantilly, VA, 20153-1200, US

(21) Appl. No.: 12/675,550

(22) PCT Filed: Aug. 29, 2008
(86) PCT No.: PCT/KR2008/005080

§ 371 Date: Jun. 17, 2010

(30) Foreign Application Priority Data
Aug. 31, 2007 (KR) 10-2007-0088490

(51) Int. Cl. F28F 1/24; B23P 15/26

(52) U.S. Cl. 165/181; 29/890.047

(57) ABSTRACT

A heat exchanger is provided. The heat exchanger includes a plurality of aluminum tubes formed of aluminum, each of the aluminum tubes including a plurality of grooves that are formed on an inner circumferential surface of each of the aluminum tubes and that extend along a longitudinal direction of the aluminum tubes; and a plurality of heat transfer fins coupled to the aluminum tubes. The heat exchanger may contribute to the reduction of the manufacturing cost, may provide high heat transfer performance and may prevent a coolant leak.

### TECHNICAL FIELD

The present invention relates to a heat exchanger, an air conditioner having the heat exchanger, and a method of manufacturing the heat exchanger, and more particularly, to a heat exchanger which includes a plurality of coolant tubes formed of aluminum and having a plurality of grooves formed therein for increasing the heat transfer area, an air conditioner having the heat exchanger and a method of manufacturing the heat exchanger.

### BACKGROUND ART

In general, air conditioners or refrigerators perform a warming operation or a cooling operation by using a refrigeration cycle including a compressor, a condenser, an expander, and an evaporator. The compressor, the condenser, the expander, and the evaporator may be connected to one another through coolant tubes, and thus, a coolant may circulate through the compressor, the condenser, the expander, and the evaporator.

The condenser and the evaporator may form a path for a coolant. The path may serve as a heat exchanger by condensing or evaporating a coolant transmitted therethrough. A fin-and-tube heat exchanger and a flat tube heat exchanger may be used as such heat exchanger.

A fin-and-tube heat exchanger may include a plurality of coolant tubes forming the paths for a coolant, and a plurality of fins coupled to the coolant tubes and increasing the heat transfer performance of the coolant tubes. The coolant tubes may be formed of copper so as to have excellent heat transfer performance.

In the meantime, Korean Utility Model Registration No. 20-0295420 discloses a fin-and-tube heat exchanger including a coolant tube formed of aluminum, which is cheaper than copper, so as to minimize the manufacturing cost. The conventional fin-and-tube heat exchanger may be fabricated by processing an aluminum film into an aluminum tube and forming a number of grooves on the aluminum tube so as to increase the inner surface area of the aluminum tube or by processing an aluminum film having a number of grooves for increasing the inner surface area of the aluminum film into an aluminum tube.

However, since the conventional fin-and-tube heat exchanger is fabricated by forming an aluminum film, forming a number of grooves on the aluminum film and bonding both ends of the aluminum film to each other, it is generally complicated to fabricate the conventional fin-and-tube heat exchanger. In addition, the conventional fin-and-tube heat exchanger may cause coolant leaks.

### DISCLOSURE OF INVENTION

### Technical Problem

The present invention provides a heat exchanger which is cheap, has excellent heat transfer properties and can minimize coolant leaks and an air conditioner having the heat exchanger.

The present invention also provides a method of fabricating a heat exchanger in which the heat transfer performance of a heat exchanger can be uniformly maintained by preventing the height of grooves formed on an aluminum tube from considerably decreasing due to a tube expansion operation.

### Technical Solution

According to an aspect of the present invention, there is provided a heat exchanger including a plurality of aluminum tubes formed of aluminum, each of the aluminum tubes including a plurality of grooves that are formed on an inner circumferential surface of each of the aluminum tubes and that extend along a longitudinal direction of the aluminum tubes; and a plurality of heat transfer fins coupled to the aluminum tubes.

According to another aspect of the present invention, there is provided an air conditioner including a heat exchanger having a plurality of aluminum tubes formed of aluminum, each of the aluminum tubes including a plurality of grooves that are formed on an inner circumferential surface of each of the aluminum tubes and that extend along a longitudinal direction of the aluminum tubes; and a plurality of heat transfer fins coupled to the aluminum tubes.

According to another aspect of the present invention, there is provided a method of fabricating a heat exchanger, the method including forming a plurality of aluminum tubes through extrusion and/or pultrusion, each of the aluminum tubes including a plurality of grooves that are formed on an inner circumferential surface of each of the aluminum tubes and that extend along a longitudinal direction of the aluminum tubes; inserting the aluminum tubes into a plurality of heat transfer fins; and expanding each of the aluminum tubes.

### Advantageous Effects

According to the present invention, since a coolant tube is formed of aluminum, which is cheaper than copper, it is possible to minimize the probability of a coolant leaking from the coolant tube. In addition, since the coolant tube includes a plurality of grooves extending along the longitudinal direction of the coolant tube, it is possible to provide high heat transfer performance.

Moreover, since the height or the number of grooves is appropriately determined in consideration of the amount by which the height of grooves is to be reduced by a tube expansion operation, it is possible to fabricate a heat exchanger having high heat transfer performance.

### BRIEF DESCRIPTION OF THE DRAWINGS

FIG. 1 illustrates a schematic diagram of an air conditioner having a heat exchanger, according to an exemplary embodiment of the present invention;

FIG. 2 illustrates a perspective view of a heat exchanger according to an exemplary embodiment of the present invention;

FIG. 3 illustrates a cross-sectional view of an aluminum tube yet to be expanded;

FIG. 4 illustrates a cross-sectional view of an expanded aluminum tube;

FIG. 5 illustrates a flowchart of a method of fabricating a heat exchanger according to an exemplary embodiment of the present invention;

FIG. 6 illustrates a graph showing the groove transformation rates of various aluminum tubes having different diameters; and

FIG. 7 illustrates a graph showing the relationship between the groove depth of an aluminum tube and the heat transfer performance of a heat exchanger.

### BEST MODE FOR CARRYING OUT THE INVENTION

The present invention will hereinafter be described in detail with reference to the accompanying drawings in which exemplary embodiments of the invention are shown.

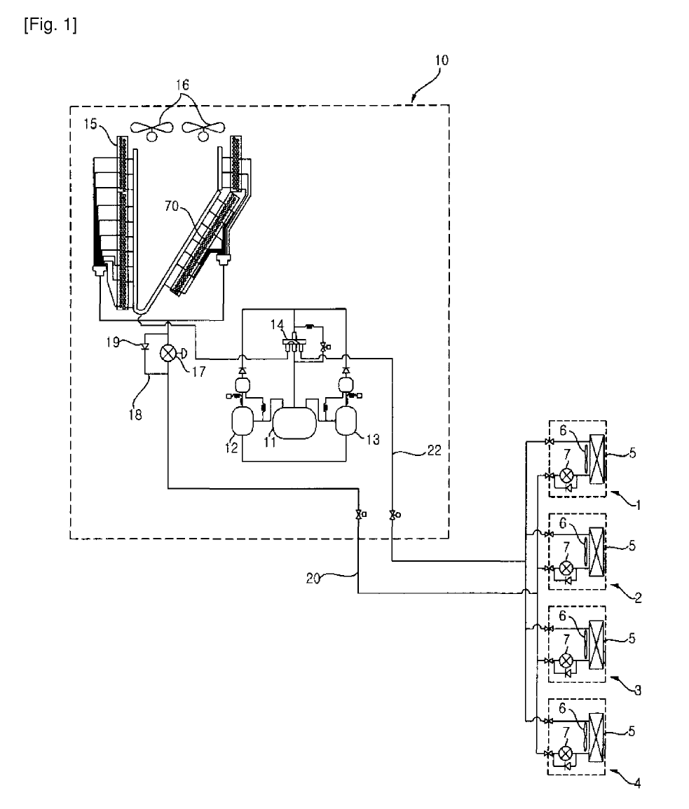

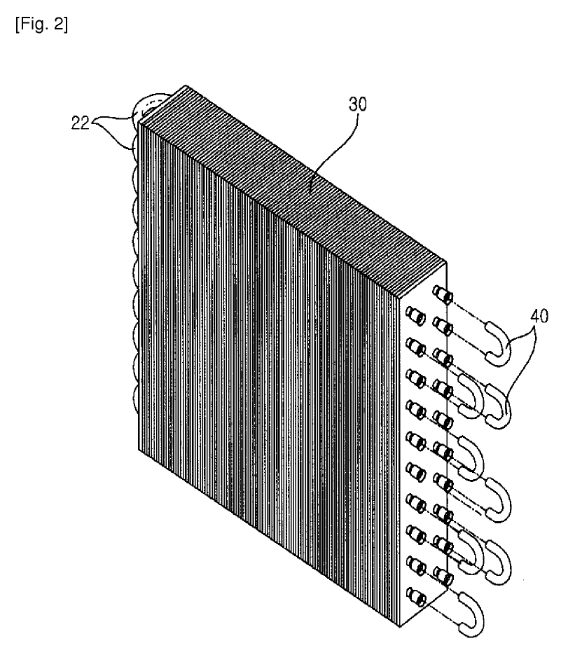

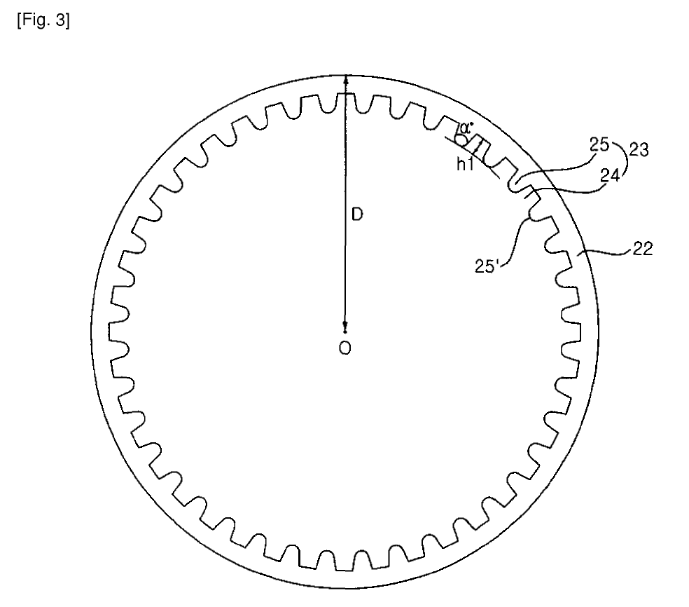

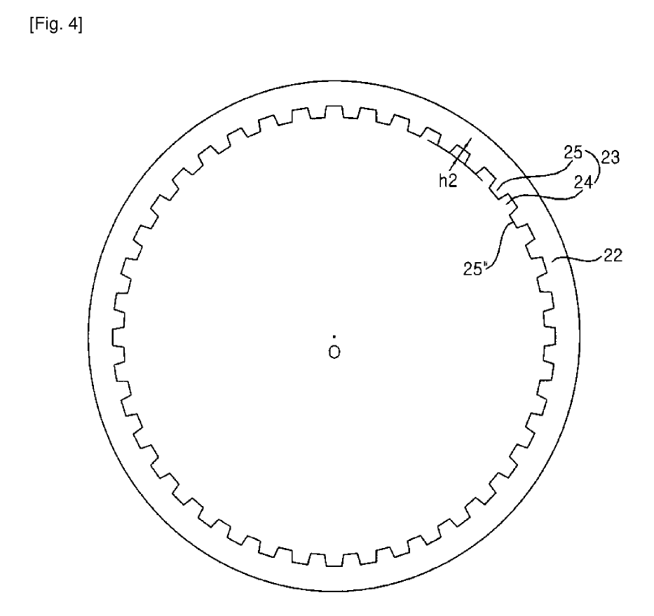

FIG. 1 illustrates a schematic diagram of an air conditioner having a heat exchanger, according to an exemplary embodiment of the present invention, FIG. 2 illustrates a perspective view of a heat exchanger according to an exemplary embodiment of the present invention, FIG. 3 illustrates a cross-sectional view of an aluminum tube 22 yet to be expanded; and FIG. 4 illustrates a cross-sectional view of an expanded aluminum tube 22.

Referring to FIG. 1, the air conditioner may include a plurality of indoor units 1 through 4, which are installed inside a building, an outdoor unit 10, and a plurality of coolant tubes 20 and 22, which connect the indoor units 1 through 4 and the outdoor unit 10.

Each of the indoor units 1 through 4 may include an indoor heat exchanger 5, which performs heat exchange on indoor air along with a coolant, an indoor blower 6, which is installed near the indoor heat exchanger 5 and circulates indoor air, and an indoor linear expansion valve (LEV) 7, which expands a coolant flown into the indoor heat exchanger 5 during a cooling operation.

The indoor units 1 through 4 are connected in parallel to each of the coolant tubes 20 and 22.

The outdoor unit 10 may include an accumulator 11, which passes therethrough only a coolant gas supplied from the indoor units 1 through 4, compressors 12 and 13, which are supplied with the gas coolant by the accumulator 11 and compress the gas coolant, a cooling/warming switching valve, which is connected to the compressors 12 and 13 and is a 4-way valve for determining a path for the compressed coolant, an outdoor heat exchanger 15, which performs heat exchange on outdoor air along with a coolant supplied from the cooling/warming switching valve 14, and an outdoor blower 16, which is installed near the outdoor heat exchanger 15 and blows outdoor air into the outdoor heat exchanger 15.

The coolant tube 20 may guide a coolant ejected from the outdoor heat exchanger 15 into the indoor units 1 through 4. An outdoor LEV 17, a bypass flow path 18 and a check valve 19 may be installed along the coolant tube 20. The outdoor LEV 17 may expand a coolant during a warming operation. The bypass flow path 18 may bypass the outdoor LEV 17. The check valve 19 may close the bypass flow path 18 during a warming operation.

During a cooling operation, the outdoor LEV 17 may be fully opened, and may thus pass a coolant compressed by the outdoor heat exchanger 15 therethrough without expanding the coolant. On the other hand, during a warming operation, the outdoor LEV 17 may be partially opened, and may thus expand a coolant compressed by the outdoor heat exchanger 15 into a liquid spray-type coolant before injecting the coolant into the outdoor heat exchanger 15.

During a warming operation, the cooling/warming switching valve 14 may flow a coolant compressed by the compressors 12 and 13 into the outdoor heat exchanger 15, and may flow the coolant into the accumulator 11. In this case, the outdoor heat exchanger 15 may serve as a condenser, and the indoor heat exchanger 5 may serve as an evaporator. During a warming operation, the cooling/warming switching valve 14 may flow a coolant compressed by the compressors 12 and 13 into the indoor heat exchanger 5, and may flow the coolant into the accumulator 11. In this case, the indoor heat exchanger 5 may serve as a condenser, and the outdoor heat exchanger 15 may serve as an evaporator.

Referring to FIG. 2, at least one of the indoor heat exchanger 5 and the outdoor heat exchanger 15 may include an array of a plurality of aluminum tubes 22, which are formed of aluminum and pass a coolant therethrough, a plurality of heat transfer fins 30, which are arranged at regular intervals and are coupled to the aluminum tubes 22, and a plurality of return bands 40, which connect the aluminum tubes 22 to one another.

The indoor heat exchanger 5 and the outdoor heat exchanger 15 may both include the aluminum tubes 22. If the influence of the heat transfer performance of the indoor heat exchanger 5 on the thermal efficiency of a refrigeration cycle is more considerable than the influence of the heat transfer performance of the outdoor heat exchanger 15 on the thermal efficiency of a refrigeration cycle and the coolant tubes of the indoor heat exchanger 5 are formed of aluminum, instead of copper, the thermal efficiency of a refrigeration cycle may considerably decrease. Therefore, in order to increase the thermal efficiency of a refrigeration cycle, the coolant tubes of the outdoor heat exchanger 15, which are expected to affect thermal efficiency less considerably than the coolant tubes of the indoor heat exchanger 5, may be formed of aluminum, and the coolant tubes of the indoor heat exchanger 5 may be formed of copper, which provides more excellent heat transfer properties than aluminum.

In order to maximize the heat transfer area of each of the aluminum tubes 22, a plurality of grooves 24 may be formed on an inner circumferential surface of each of the aluminum tubes 22.

The more grooves 24 each of the aluminum tubes 22 has, the larger the heat transfer area of each of the aluminum tubes 22 becomes. Thus, as many grooves 24 as possible may be formed on each of the aluminum tubes 22 in consideration of the strength of the aluminum tubes 22 and the precision of the grooves 24. A plurality of protrusions 25 may be formed among the grooves 24, and may protrude beyond the grooves 24 toward a center O of the aluminum.

The grooves 24 and the protrusions 25 may be alternately formed on the inner circumferential surface of each of the aluminum tubes 22 and may form a plurality concavo-convex portions 23. The grooves 24 and the protrusions 25 may have the same cross-sectional area.

Each of the aluminum tubes 22 may be formed by extrusion and/or pultrusion. The grooves 24 and the protrusions 25 may extend along the longitudinal direction of each of the aluminum tubes 22 or may extend along a spiral direction of each of the aluminum tubes 22. In particular, in order to facilitate the fabrication of the grooves 24, the grooves 24 and the protrusions 25 may be formed so as to extend along the longitudinal direction of each of the aluminum tubes 22.

The grooves 24 and the protrusions 25 may have a rectangular cross-sectional shape or a circular cross-sectional shape. More specifically, the heat transfer area of the aluminum tubes 22 may be larger when the grooves 24 and the protrusions 25 have a rectangular cross-sectional shape than when the grooves 24 and the protrusions 25 have a circular cross-sectional shape. Thus, in order to improve the heat transfer performance of each of the aluminum tubes 22, the grooves 24 and the protrusions 25 may be formed to have a rectangular cross-sectional shape.

The protrusions 25 may be initially formed through extrusion and/or pultrusion to have curved tops 25′ protruding toward the center O of each of the aluminum tubes 22, as shown in FIG. 3. Thereafter, the protrusions 25 may be planarized through tube expansion so as to have flat tops 25″, as shown in FIG. 4.

It is possible to facilitate the flow of a coolant along the grooves 24, minimize coolant loss, and improve the uniformity in the shape of the grooves 24 or the protrusions 25 by forming the grooves 24 and the protrusions 25 to have a trapezoidal shape, rather than a rectangular or regular rectangular shape.

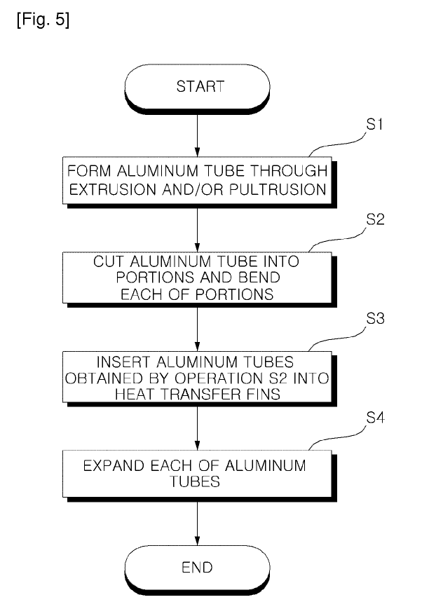

FIG. 5 illustrates a flowchart of a method of fabricating a heat exchanger according to an exemplary embodiment of the present invention. Referring to FIG. 5, the method includes forming an aluminum tube (S1), cutting and bending the aluminum tube (S2), inserting the aluminum tube into a heat transfer fin (S3), and expanding the aluminum tube (S4).

More specifically, an aluminum tube including a plurality of grooves 24 is formed using an aluminum tube molding device and using extrusion and/or pultrusion (S1). The grooves 24 may be formed on the inner circumferential surface of the aluminum tube and may extend along the longitudinal direction of the aluminum tube.

In operation S1, the aluminum tube may be formed to include a plurality of protrusions 25 having curved tops 25′ that protrude toward the center O of the aluminum tube.

The height of the grooves 24 may be reduced from h1 to h2 by a tube expansion operation to be performed in operation S4. Thus, in operation S1, the aluminum tube may be formed in consideration of the amount by which the height of the grooves 24 is to be reduced by a tube expansion operation, such that the height h2 can amount to at least 80% of the height h1.

That is, in operation S1, the aluminum tube may be formed such that the grooves 24 can maintain a predetermined height even after being subjected to operation S4. The number N of grooves 24 may be determined by Equation (1) below:

30×D/7<N<50×D/7 Equation (1)

where D is the external diameter of the aluminum tube.

The height of the grooves 24 may be determined by Equation (2) below:

45/E×D/7<h/0.07<D Equation (2)

where E is the elongation ratio of the aluminum tube.

The external diameter D may be determined to be within the range of 4 mm-10 mm in consideration of operation S4.

The elongation ratio E may be within the range of 13-45.

The angle between a pair of adjacent grooves 24, and particularly, the angle α of the curved tops 25′ of the protrusions 25, may be within the range of 10°-30°.

Once the aluminum tube is formed, the aluminum tube may be cut into a plurality of portions, and each of the portions may be bent in a U shape (S2), thereby obtaining a plurality of aluminum tubes 22.

Thereafter, the aluminum tubes 22 may be inserted into a plurality of heat transfer fins 30 (S3).

Thereafter, each of the aluminum tubes 22 may be expanded using a tube expansion device (not shown) (S4) so that the aluminum tubes 22 can be firmly attached to the heat transfer fins 30. As a result of operation S4, the round tops 25 of the protrusions 25 may be transformed into flat portions 5′.

The tube expansion device may insert a rod-type pressurizing element into each of the aluminum tubes 22 or may insert a high-pressure fluid into each of the aluminum tubes 22. As a result of operation S4, the diameter of the aluminum tubes 22 may increase, and the height of a plurality of concavo-convex regions 3 of each of the aluminum tubes 22, and particularly, the depth of the grooves 24 and the height of the protrusions 25, may decrease.

Thereafter, the aluminum tubes 22 may be connected to one another by a plurality of return bands 40, which are U-shaped.

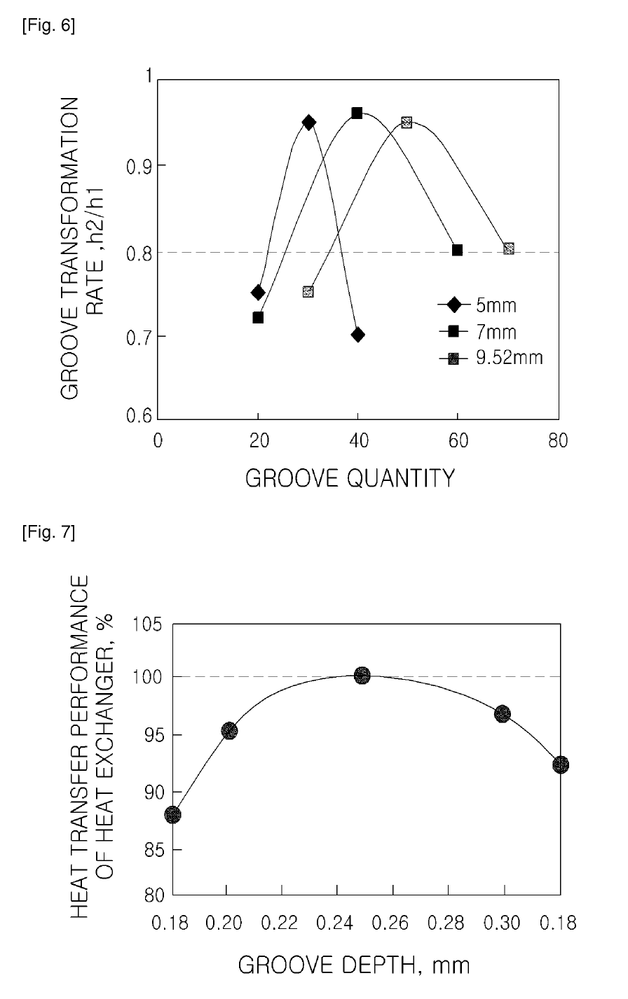

FIG. 6 illustrates a graph showing the groove transformation rates of various aluminum tubes having an elongation ratio of 30 and having different diameters. Referring to FIG. 6, the groove transformation rate of an aluminum tube indicates the ratio of the height h1 of grooves of an aluminum tube yet to be expanded and the height h2 of grooves of an expanded aluminum tube. Referring to FIG. 6, when the diameter of an aluminum tube is 5 mm and the number of grooves of the aluminum tube is within the range of 20-40, the groove transformation rate (h2/h1) of the aluminum tube may be more than 0.8. When the diameter of an aluminum tube is 9.52 mm and the number of grooves of the aluminum tube is within the range of 35-70, the groove transformation rate (h2/h1) of the aluminum tube may be maintained at 0.8 or more. If the number of grooves of an aluminum tube is determined using Equation (1), it is possible to maintain the groove transformation rate (h2/h1) of the aluminum tube at 0.8 or more.

Preferably, the diameter of an aluminum tube may be 7 mm, and the number of grooves of the aluminum tube may be within the range of 38-42. In this case, it is possible to minimize the groove transformation rate of an aluminum tube.

FIG. 7 illustrates a graph showing the relationship between the heat transfer performance of a heat exchanger and the depth of grooves of an aluminum tube when the aluminum tube has a diameter D of 7 mm. Referring to FIG. 7, the heat transfer performance of a heat exchanger may be highest when the depth of grooves of an aluminum tube is about 0.25 mm. If the depth of grooves of an aluminum tube is determined using Equation (2), it is possible for a heat exchanger to secure high heat transfer performance.

Referring to Equation (2), the depth of grooves of an aluminum tube is proportional to the diameter of the aluminum tube and is inversely proportional to the elongation ratio of the aluminum tube. If the elongation ratio of an aluminum tube is low, the groove transformation rate of the aluminum tube may increase. Given this, the greater the depth of grooves, the better for a give tube diameter.

For example, if an aluminum tube has a diameter of 7 mm and an elongation ratio of 30, a plurality of grooves may be formed to a depth of 0.105 mm-0.49 mm. In this case, it is possible to improve the heat transfer performance of a heat exchanger.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

The heat exchanger includes a plurality of aluminum tubes formed of aluminum, each of the aluminum tubes including a plurality of grooves that are formed on an inner circumferential surface of each of the aluminum tubes and that extend along a longitudinal direction of the aluminum tubes; and a plurality of heat transfer fins coupled to the aluminum tubes. The heat exchanger may contribute to the reduction of the manufacturing cost, may provide high heat transfer performance and may prevent a coolant leak.

1. A heat exchanger comprising:
a plurality of aluminum tubes formed of aluminum, each of the aluminum tubes including a plurality of grooves that are formed on an inner circumferential surface of each of the aluminum tubes and that extend along a longitudinal direction of the aluminum tubes; and
a plurality of heat transfer fins coupled to the aluminum tubes.

2. The heat exchanger of claim 1, wherein a number of grooves included in each of the aluminum tubes satisfies the following equation:
30×D/7<N<50×D/7
where N indicates the number of grooves included in each of the aluminum tubes and D indicates an external diameter of the aluminum tubes, the external diameter being within the range of 4 mm-10 mm.

3. The heat exchanger of claim 2, wherein a height of the grooves satisfies the following equation:
45/E×D/7<h/0.07<D
where E indicates an elongation ratio of the aluminum tubes.

4. The heat exchanger of claim 3, wherein the aluminum tubes have an elongation ratio of 13-45.

5. An air conditioner comprising the heat exchanger of claim 1.

6. A method of fabricating a heat exchanger, the method comprising:
forming a plurality of aluminum tubes through extrusion and/or pultrusion, each of the aluminum tubes including a plurality of grooves that are formed on an inner circumferential surface of each of the aluminum tubes and that extend along a longitudinal direction of the aluminum tubes;
inserting the aluminum tubes into a plurality of heat transfer fins; and
expanding each of the aluminum tubes.

7. The method of claim 6, wherein a number of grooves included in each of the aluminum tubes satisfies the following equation:
30×D/7<N<50×D/7
where N indicates the number of grooves included in each of the aluminum tubes and D indicates an external diameter of the aluminum tubes, the external diameter being within the range of 4 mm-10 mm.

8. The method of claim 7, wherein a height of the grooves satisfies the following equation:
45/E×D/7<h/0.07<D
where E indicates an elongation ratio of the aluminum tubes.

9. The method of claim 9, wherein the aluminum tubes have an elongation ratio of 13-45.

10. The method of claim 9, wherein the aluminum tubes have an external diameter of 7 mm.
